(19) United States
(12) Patent Application Publication
(10) Pub. No.: US 2002/0045376 A1
(43) Pub. Date: Apr. 18, 2002

(54) Auxiliary machine module and method of manufacturing the same

(75) Inventors: Kimihiro Abe, Shizuoka (JP); Isao Kameyama, Shizuoka (JP); Takakazu Takahashi, Shizuoka (JP)

Correspondence Address: ARMSTRONG,WESTERMAN & HATTORI, LLP, 1725 K STREET, NW., SUITE 1000, WASHINGTON, DC, 20006, US

(73) Assignee: Yazaki Corporation, Tokyo, JP

(21) Appl. No.: 09/974,058

(22) Filed: Oct. 11, 2001

(30) Foreign Application Priority Data
Oct. 13, 2000 (JP) 2000-313736

(51) Int. Cl. H01R 13/64

(52) U.S. Cl. 439/374

(57) ABSTRACT

An auxiliary machine module includes auxiliary machine a base plate equipped with the auxiliary machine; a case in which the base plate is mounted, and a connector tool for electrically connecting the base plate and the case. In this configuration, the number of components provided on the periphery of the auxiliary machine module, and the module can be reduced in size and weight in a simple structure. An inconvenience occurring in a conventional assembling operation can be also overcome.

### BACKGROUND OF THE INVENTION

1. Field of the Invention

This invention relates to an auxiliary machine module which can connector-connect an auxiliary machine such as an in-vehicle CCD camera, base plate equipped with the auxiliary machine and case on which the auxiliary machine and base plate are installed, thus providing good productivity and high production yield.

2. Description of the Related Art

Now referring to FIGS. 13 to 16, an explanation will be given of conventional camera modules Y and Z. FIG. 13 is a partially enlarged view of a wire harness 4 connected to a clamp 10 equipped with an O-ring 11. The clamp 10 is provided with the O-ring 11 in order to keep airtightness when the clamp 10 is attached to a camera case 3.

The clamp 10 includes a thread cutting portion 10a which permits the clamp 10 to be surely secured to a camera case 3, a hexagonal head 10b which is used when the clamp 10 is secured to the camera case by screw-tightening, and a flange 10c which generates tightening force between the clamp 10 and camera case 3 and facilitates the sealing function of the O ring.

The clamp 10 has an internal though-hole 10d through which electric wires such as cables 4a, and drain wire 4a′ (hereinafter generally referred to as cables 4a, 4a′) are to pass. As seen from FIG. 14, the cables 4a, 4a′ are passed through the through-hole of the clamp 10 equipped with the O-ring 11. Terminals 5p are attached to the ends of the cables 4a, 4a′, respectively.

After the cables 4a, 4a′ have been passed through the through-hole 10d of the clamp 10, they are subjected to processing of potting. The potting is to pour soft rubber or soft resin such as epoxy polymer into a predetermined position to be sealed.

The potting permits the individual cables 4a, 4a′ to be sealed completely so that entry of water, dust, etc in the interior of the camera case or camera can be prevented. The sealing of the area subjected to the potting can be confirmed in terms of airtightness or watertightness due to moistening.

FIGS. 14 and 15 are perspective views each showing the assembly of camera modules Y and Z equipped with a conventional in-vehicle CCD camera. The camera module Y includes a camera 1 such as an in-vehicle CCD camera and a base plate 2 to which the camera 1 is attached. The camera module Z includes the camera module Y, a camera case 3 to which the camera module Y is attached and a wire harness 4 of various kinds of cables 4a, 4a′ tied in a bundle.

FIGS. 14 and 15 show the process of assembling the conventional camera module. Specifically, FIG. 15 shows an inconvenience occurring when the camera module Y is mounted in the camera case 3. FIG. 16 shows a conceptual view of the section taken in line R-R in FIGS. 14 and 15 and connection of the wire harness 4, more specifically shows the state where the wire harness 4 is attached to the camera case 3 through the clamp 10.

Meanwhile, the CCD (charged coupled device) is a device for converting an optical signal such as an image into an electric signal using a semiconductor device which is reactive to light. The CCD is a semiconductor device developed in 1970 by Bell Telephone in USA. Generally, the image quality of the CCD depends on the number of pixels, which is set in a wide range of several hundred thousands to several millions. The number of pixels may be further increased in accordance with demands.

The CCD has been widely used in cameras such as a digital camera, video camera, etc. and copy machines such as facsimile, scanner, photocopying machine, laser beam printer, etc. In the case of the digital camera, the CCD is arranged in place of a silver film at a focal point. In recent years, the CCD having a large number of pixels has become inexpensive. This greatly contributes to low-price and high image quality of the digital camera.

A detailed explanation will be given of each of components of the conventional camera module Z. A camera 1 is composed of a lens 1c and a lens peripheral portion 1d for securing it. The camera 1 is attached to a base plate 2 which is mainly constructed of a base plate body 2′. Electric components such as connectors for electrical connection are installed on the base plate body 2′. The base plate body 2′ is provided with a connector housing 2c related to the connector. Four through-holes 2b through which screws 13b are passed to secure the base plate 2 to a camera case 3 are made in the vicinity of four corners of the base plate body 2′.

The camera case 3 is constructed of a bottom wall 3c and side walls 3d, 3d′ which encircle its four sides. A cylindrical projection 3g, which serves to secure the clamp 10 and seal the inside of the camera case 3, is attached to the side wall 3d′. Securing pieces 3a for securing the base plate 2 equipped with the camera 1 are provided at four corners of a chamber 3e of the camera case 3. A female hole 3b is made in each of the securing pieces 3a.

Now referring to FIG. 16, a detailed explanation will be given of the attaching state between the clamp 10 and camera case 3. A through-hole 3f through which a wire harness 4, i.e. a bundle of cables 4a, 4a′ is passed is made in the side wall 3d′ of the camera case 3. A female screw groove is formed on the inner peripheral face of the through-hole 3f so that it is screwed with a screwed portion 10a of the claim 10, thereby surely securing the clamp 10.

The clamp 10 with the cables 4a, 4a′ shown in FIG. 13 is fit in the through-hole 3f. The screwed portion 10a of the clamp 10 is engaged with the screwed through-hole of the camera case 3. Thus, the clamp 10 is secured to the camera case 3 as also shown in FIG. 16.

The cylindrical projection 3g keeps the airtightness by the O-ring 11 so that it serves as a shading plate for preventing entry of water and dust from the outside.

The wire harness 4 as shown in FIG. 16 connects the camera case 3 to a non-waterproof connector 5r located within a vehicle V. The drain cable 4a′ branched from the middle portion of the wire harness 4 is provided with a terminal 5s which is a frame of a vehicle body B through a screw 13c. In this way, the drain wire 4a′ serves as an earth.

As shown in FIGS. 14 and 15, the cable 4a′, 4a and the camera 1 are electrically connector-connected in such a manner that a connector housing 5q with the cables 4a, 4a′ connected therewith is fit in the connector housing 2c. In this way, the base plate 1 is electrically connected to the wire harness 4 and non-waterproof connector 5r located within the vehicle V and drain cable 4a′.

An explanation will be given of a typical method of assembling the in-vehicle CCD camera. First, the clamp 10 equipped with the O ring 11 is attached to the wire harness 4. The wire harness 4 is passed through the through-hole 10d of the clamp 10 so that the wire harness 4 and clamp 10 are provisionally fixed.

In the segment of the wire harness 4 which is to be entered into the camera case 3, a tube 4d which protectively covers the cables 4a, 4a′ is cut up by a blade so that the cables 4a, 4a′ are taken out from the tube 4d. A terminal 5p is attached to the end of each of the cables 4a, 4a′. The terminal 5p is accommodated within the connector housing 5q as shown in FIG. 14.

In order to improve the sealing degree between the wire harness and clamp 10, as shown in FIG. 13, the through-hole 10d of the clamp 10 is subjected to potting processing 12 that resin or rubber is poured into the through-hole 10d. Thus, the wire harness 4 and clamp 10 are secured to each other. The potting processing 12 as shown in FIGS. 13 and 16 improves the airtightness within the camera 3.

The operation of combining the wire harness 4 and the peripheral components thereof is generally referred to assembling the wire harness 4 and connector, or may be simply referred to “connector assy”. In this case, in order that the camera case 3 is connected to the base plate 2, with the cables 4a, 4a′ given a slight redundant length as seen from FIGS. 14 and 15, the clamp 10 is secured to the wire harness 4 at its prescribed position.

As shown in FIG. 16, the clamp 10 is attached to the through-hole 3f of the camera case 3. The threaded portion 10a of the clamp 10 is engaged with the through-hole 3f, i.e. female-threaded hole of the camera case 3 so that the clamp 10 is secured to the camera case 3 as shown in FIGS. 14 to 16. In this case, as seen from FIG. 16, the O-ring 11 and the potting processing 12 keep the airtightness or hermeticity of the inside of the camera case 3.

Thereafter, the base plate 2 with the camera 1, i.e. camera module Y is attached to the camera case 3 as follows. First, as shown in FIGS. 14 and 15, the connector component equipped with the connector housing 5q on the side of the wire harness 4 is connected to the connector component 2c attached to the base plate body 2′.

The camera module Y is attached to the camera case 3 as follows. The through-holes 2b of the base plate body 2′ are aligned with the female threaded holes 3b of the camera case 3 at four corners.

The screws 13b are passed through the through-holes 2b of the base plate body 2′ and screwed in them by a driver. Thus, the screws 13b are tightened into the female threaded holes 3b of the camera case 3. In this way, the camera module Y is secured to the camera case 3 to complete the camera module Z.

A connector wiring device as a related art is disclosed in J-UM-7-42075. J-UM-7-42075 mainly discloses an alignment holding mechanism for automatically aligning a plurality of paired cables without changing the order of their combinations in a line in a connector wiring device for automatically wiring the cores of the plurality of paired cables on a cover for provisionally fixing a connector.

However, as seen from FIGS. 14 and 15, in the conventional technique, the camera module Y was manually connected to the connector attached to the end of the cable 4a. Therefore, a worker was required to make a troublesome operation. Namely, with the cables 4a, 4a′ arranged in the chamber 3e of the camera case and secured by the clamp 10, the assembling made by connecting the connectors provides poor workability.

Concretely, in the prior art, the through-hole 3f through which the cables 4a, 4a′ are to be passed is formed in the camera case 3. The connector attached to the cables 4a, 4a′ passed through the through-hole 3f is connected to another connector attached to the base plate 2. In assembling, therefore, the worker must make a troublesome operation.

In the conventional camera case 3, the through-hole 3f is threaded. In order to enhance the hermeticity, the operator must screw the clamp 10 into the through-hole 3f so that the clamp 10 equipped with the wire harness is installed in the camera case.

FIG. 15 is a perspective view for explaining an inconvenience when the camera module Y is combined with the camera case 3. Namely, as shown in FIG. 15, when the camera module Y is combined with the camera case 3, catching of the cables 4a, 4a′ may occur.

### SUMMARY OF THE INVENTION

An object of this invention is to provide an auxiliary machine module which can connect cables and a base plate while the base plate equipped with an auxiliary machine such as a camera and terminals such as caulking terminals is mounted in a case, thereby reducing the number of components arranged around the auxiliary machine.

Another object of this invention it to provide an auxiliary machine module which can prevent occurrence of catching of electric cables when the base plate equipped with the auxiliary machine such as a camera is mounted in the case.

Still another object of this invention is to provide an auxiliary machine module which can reduce the number of defective articles in connector-connection, and speed up and facilitate assembling.

A further object of this invention is to provide a method of manufacturing an auxiliary machine module which has the features described above.

In accordance with this invention, there is provided an auxiliary machine module comprising:

an auxiliary machine;

a base plate equipped with the auxiliary machine and a caulking connector;

a case in which the base plate is mounted, and a connector means for electrically connecting the base plate and the case.

In this configuration, the auxiliary machine, base plate and case can be designed in a module so that the number of peripheral components can be reduced, and the module can be reduced in size and weight in a simplified structure. In addition, concurrently with mounting of the base plate in the case, electrical connection can be made therebetween.

Preferably, the base plate has a caulking connector composed of a first connector housing and caulking terminals and the case has a second connector housing in which electric wires are housed, and the connector means is formed when the base plate is attached to the case so that the caulking terminals are caulking-connected to the electric wires.

In this configuration, since caulking connection is made using the caulking terminals, the base plate and case can be electrically connected to each other when they are combined with each other.

Preferably, the first connector housing has a pair of guiding walls which are to be brought into sliding-contact with the second connector before the caulking terminals are caulking-connected to the wires, respectively.

In this configuration, when the base plate is combined with the case, the former can be lowered with no tilting towards the case.

Preferably, wherein the guiding walls are longer than the caulking terminals and shorter than a height of the second connector housing.

In a configuration, the guiding walls serve as a guiding means more appropriately.

Preferably, the first connector housing has a pair of locking pieces and the second connector housing has a pair of engagement portions to be engaged with the pair of locking pieces.

In this configuration, the locking pieces can be fit in the engagement pieces so that the base plate can be coupled with the case easily, quickly and surely.

Preferably, the auxiliary machine is a camera attached to a motor vehicle so that the auxiliary machine module constitutes a camera module.

In this configuration, the camera, base plate and case can be designed in a module so that the number of peripheral components of the camera can be reduced, and the module can be reduced in size and weight in a simplified structure. In addition, concurrently with mounting of the base plate in the case, electrical connection can be made therebetween.

In accordance with this invention, there is provided a method of manufacturing an auxiliary machine module comprising the steps:

attaching an auxiliary machine to a base plate; and

mounting the base plate in a case so that the base plate is electrically connected to the case by means of a connector means.

In a such a method, the auxiliary machine module can be assembled quickly and effectively.

Preferably, in the method of manufacturing the auxiliary machine module, the base plate has a caulking connector composed of a first connector housing and caulking terminals and the case has a second connector housing in which electric wires are housed, and the connector means is formed when the base plate is attached to the case so that the caulking terminals are caulking-connected to the electric wires.

In the method, using the caulking connector, the caulking terminals are caulking-connected to the wires on the case. Therefore, concurrently with assembling of the auxiliary machine module, the base plate can be electrically connected to the case.

In the method of manufacturing an auxiliary machine, the auxiliary machine is a camera attached to a motor vehicle so that the auxiliary machine module constitutes a camera module.

Therefore, even when the camera and its peripheral components malfunction, the camera module can be easily dismantled so that it can be removed from the motor vehicle, and easily inspected and repaired.

The above and other objects and features of the invention will be more apparent from the following description taken in conjunction with the accompanying drawings.

### BRIEF DESCRIPTION OF THE DRAWINGS

FIG. 1 is an exploded perspective view of an embodiment of an auxiliary module according to this invention;

FIG. 2 is a conceptual view of the upper face of a case and connection of cables as shown in FIG. 1;

FIG. 3 is an exploded perspective view of another embodiment of an auxiliary module according to this invention;

FIG. 4 is a conceptual view of the upper face of a case and connection of cables as shown in FIG. 3;

FIG. 5 is a sectional view taken in line Q-Q in FIG. 3, which explains attachment of a caulking connector to a connecting portion;

FIG. 6 is an enlarged perspective view of the caulking connector as shown in FIG. 1;

FIG. 7 is an enlarged perspective view of the caulking connector as shown in FIG. 3;

FIG. 8 is an enlarged view showing the state immediately before the caulking-connection between the caulking terminal as shown in FIGS. 1, 3 and 5 and cables;

FIG. 9 is an enlarged view showing the state after the caulking-connection between the caulking terminal and cables as shown in FIG. 8 has been started;

FIG. 10 is an enlarged view showing the state after the caulking-connection between the caulking terminal and cables as shown in FIG. 9 has been completed;

FIG. 11 is an enlarged perspective view of the state when the cables have been attached to a wire fixing portion;

FIG. 12 is a sectional view of an entrance case and a cover therefor, taken in line P-P in FIG. 3;

FIG. 13 is a partially enlarged view of the wire harness mounted in a clamp equipped with an O ring;

FIG. 14 is a perspective view of the state when a conventional camera module is assembled;

FIG. 15 is a perspective view of the inconvenient state when the camera module is assembled with the camera case; and

FIG. 16 is an enlarged sectional view taken in line R-R in FIGS. 14 and 15.

### DESCRIPTION OF THE PREFERRED EMBODIMENTS

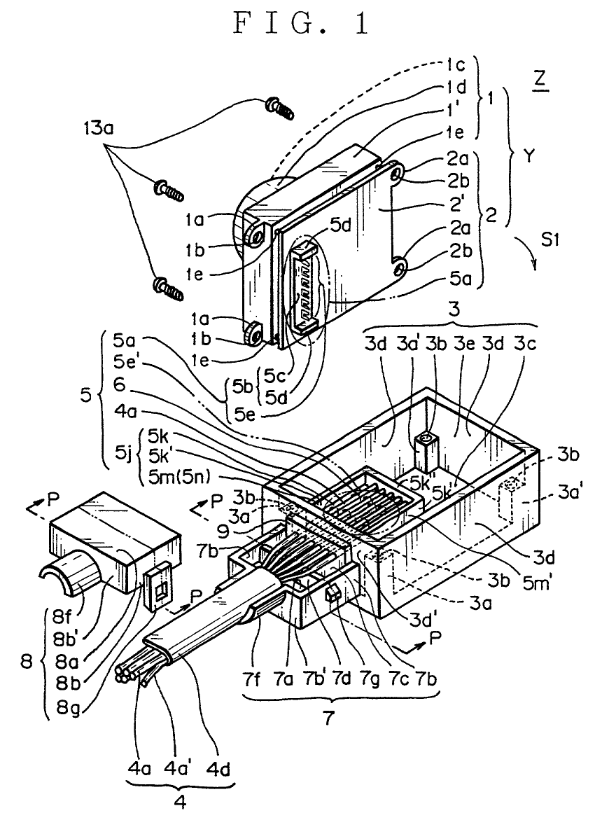

Now referring to FIGS. 1 to 12, an explanation will be given of a camera module which is an example of an auxiliary machine module according to this invention. In FIGS. 1 to 12, like reference numerals refer to like elements in the conventional auxiliary machine module as described above.

Referring to FIGS. 1, 3 and 5, in a vertical direction, an upper side refers to the side where the lens 1c of a camera module Z is located, whereas a lower side refers to a side where the bottom wall 3c of the camera case 3 is located. Referring to FIGS. 1 to 4, in a horizontal direction (back and forth), a front side refers to the side to which the cables constituting a wire harness are extended, whereas a rear side refers to the side opposite thereto.

Now, an assembly composed of at least two members, i.e. an auxiliary machine such as a camera 1 and a base plate 2 to which the camera 1 is attached is referred as an auxiliary machine module, more concretely a camera module Y. Further, an assembly composed of at least three members, i.e. the auxiliary machine such as the camera 1, base plate 2 to which the camera 1 is attached and a camera case 3 to which the base plate 2 is attached is referred to as an auxiliary module Z, more concretely a camera module Z.

The connector in this invention refers to a component for electric connection including members such as a terminal, electric wires, etc. The connector may be combined with packing, rubber stop, rear holder, etc. The connector incorporating a male terminal is generally referred to as a male connector, and the connector incorporating a female terminal is generally referred to as a female connector. In this invention, the component including at least a terminal and a connector housing is referred to as a “connector”.

The electric wires in this invention generally include the wire harness 4, cable 4a or core wire inclusive of a drain wire 4a′, or a conductor 4b with no coating. The cable 4a, 4a′ in this invention is also referred to as a core wire, and may be a single conductor 4b or plural conductors 4b each covered with an insulating coating 4c or enamel material.

The camera used in this invention may be any camera such as a camera using CCD, MOS, etc. Now, the solid-state image pick-up device of CCD which can be typically used in this invention.

The CCD includes a photodiode (photosensitive element) transfer gate and an overflow drain. The CCD has a transfer system inclusive of a frame transfer, an interline transfer, etc. in a manner of taking out charges. The CCD is provided with a vertical transfer portion beside a photosensitive portion. A transfer gate is located between the transfer portion and the photosensitive portion. Such a CCD adopts a highly resistive substrate and is provided with a p type well beneath an n type layer of the vertical transfer portion so that photocharges generated at the inner part of the substrate are prevented from flowing into the transfer portion. This suppresses a smear phenomenon.

The solid-state image pick-up device of CCD densely incorporates a photosensitive portion, an overflow drain, a vertical/horizontal transfer portion, etc. on a Si substrate having a size of 10 mm square. About two hundred thousands to six millions of picture cells (pixels) are orderly arranged in a grid pattern. With respect to the number of picture cells, where 2000 pixels in row and 1500 pixels in column are arranged, the total number of pixels are 2000×1500=3000000 (three millions).

When an optical image of a subject body is focused on the surface of the substrate through a lens, photoelectrons the number of which corresponds to the brightness are generated in the respective pixels. Thus, the subject body is converted into an image of electrons. A large number of pixels are decomposed into horizontal scanning lines so that the photoelectrons will be taken out as a video signal.

Specifically, when a transfer pulse is applied to the photo-charges generated by incident light, the photoelectrons are simultaneously shifted to the vertical transfer CCD. When the transfer pulse is applied to the vertical transfer CCD, the charges are sequentially transferred from a pixel to another pixel in the CCD. They eventually reach the horizontal transfer CCD. This time, they are sequentially transferred for each of the horizontal scanning periods so that they are taken out as a signal from the output portion.

It has been demanded to increase the sensitivity of the CCD. However, as the case may be, a wide photosensitive area cannot be assured for this purpose. A proposal for overcoming such an inconvenience is to use a solid-state image pickup device in a double-layer structure in which high-sensitive elements such as target films of an image pick-up tube are stacked on the charge transfer portion. A future solid-state image pick-up device is expected to increase the sensitivity so as to be equal to that of the image pick-up tube, to increase the number of pixels to improve the resolution and reduce moiré, and further reduce an image size, thereby realizing high performance at low cost.

The MOS (metal-oxide-semiconductor) device which is mainly used as an integrated circuit has an advantage of low power consumption. The MOS type solid-state image pick-up device generates the optical charges corresponding to the intensity of incident light, and includes a large number of aligned pixels each composed of a photodiode having a function of temporarily storing the optical charges and a transistor serving as a switch for deriving the stored charges.

Referring to FIGS. 1 and 2, and FIGS. 3 and 4, an explanation will be given of the operation of assembling the camera module. Referring to FIGS. 5 to 12 also, the specific parts in FIGS. 1 to 4 are illustrated in an enlarged scale.

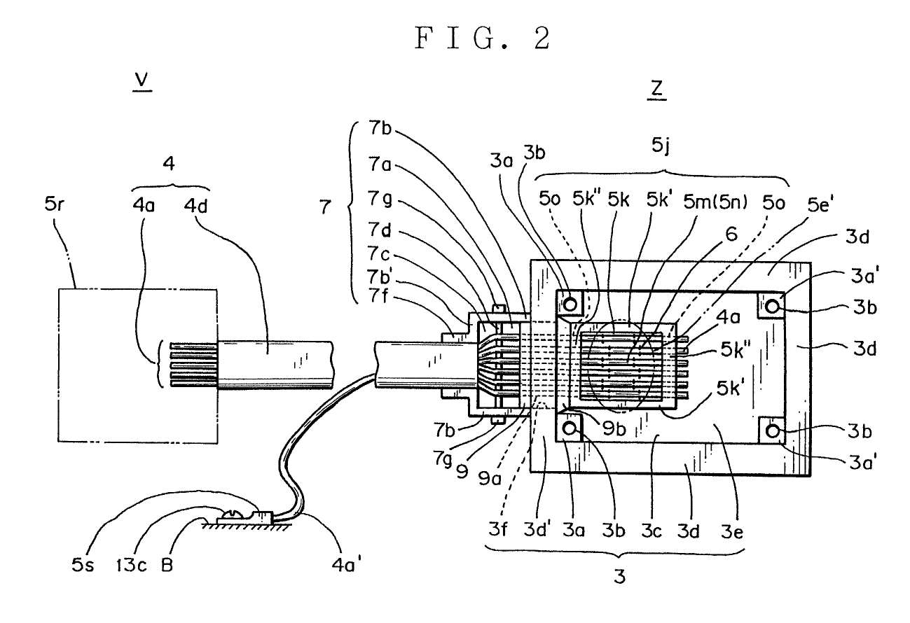

FIG. 1 is an exploded perspective view of an embodiment of a camera module as an auxiliary machine module Z according to this invention. FIG. 2 is a conceptual view of the upper face of a camera case 3 and connection of cables (wire harness) shown in FIG. 1.

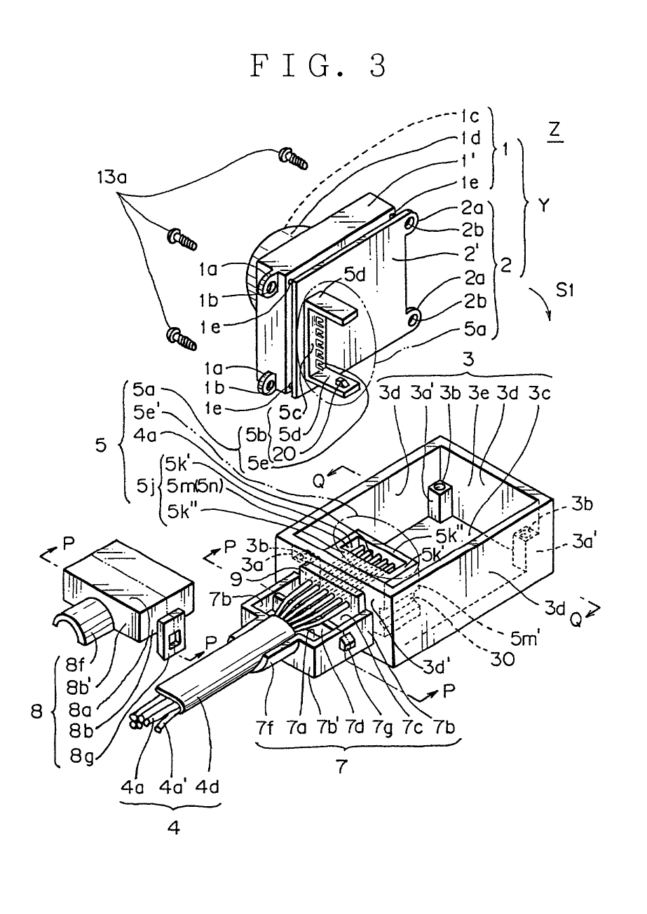

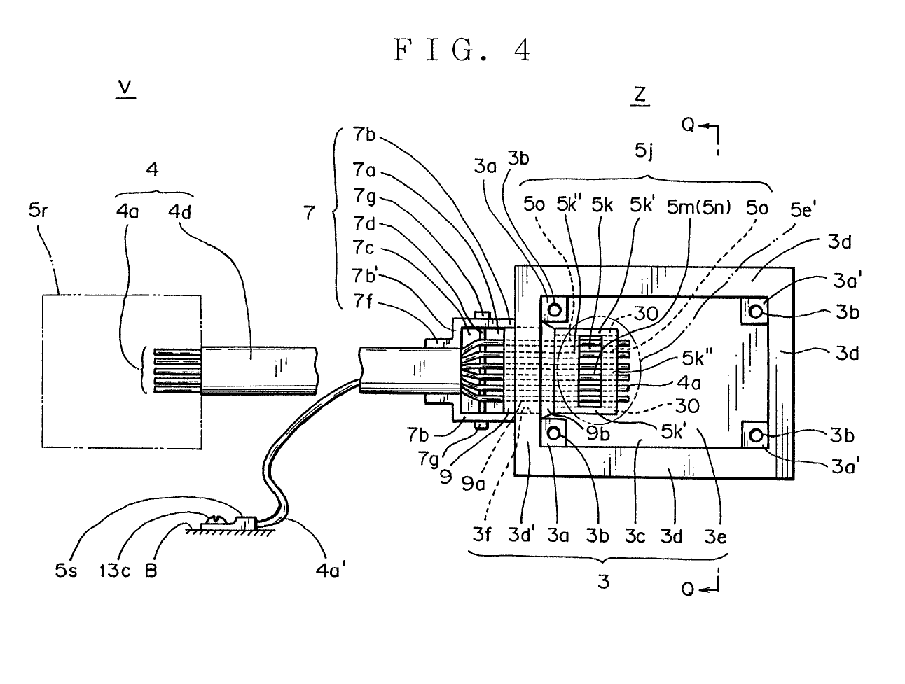

FIG. 3 is an exploded perspective view of another embodiment of a camera module as an auxiliary module Z according to this invention. FIG. 4 is a conceptual view of the upper face of a camera case 3 and connection of cables (wire harness) shown in FIG. 3. FIG. 5 is a sectional view taken in line Q-Q in FIG. 3, which shows the state where the crimping connector 5a shown in FIG. 3 has been attached to the connection portion 5e′ of the connector housing 5j. FIGS. 1 and 3 illustrate the state where the camera module Y composed of the camera 1 equipped with CCD and base plate 2 attached to it and case cover 8 are to be attached to prescribed positions of the camera case 3.

As seen from FIGS. 1, 3 and 5, the camera module Z includes at least the camera 1 equipped with the CCD, base plate 2 having caulking terminals 5e on which the camera 1 is attached, and a camera case 3 in which the base plate 2 is mounted. The base plate 2 is mounted in the camera case 3 along a mounting direction so that the caulking terminals 5e of the base plate 2 and the connecting portion 5e′ are electrically connected to each other to constitute a connector 5.

In this way, the camera 1, base plate 2 and camera case 3 are configured as a module, and the number of the peripheral components can be reduced. The camera module Z is reduced in size and weight, and the assembling structure thereof can be simplified. Since the base plate 2 is installed on the camera case, the assembling and electrical connection therebetween can be simultaneously realized.

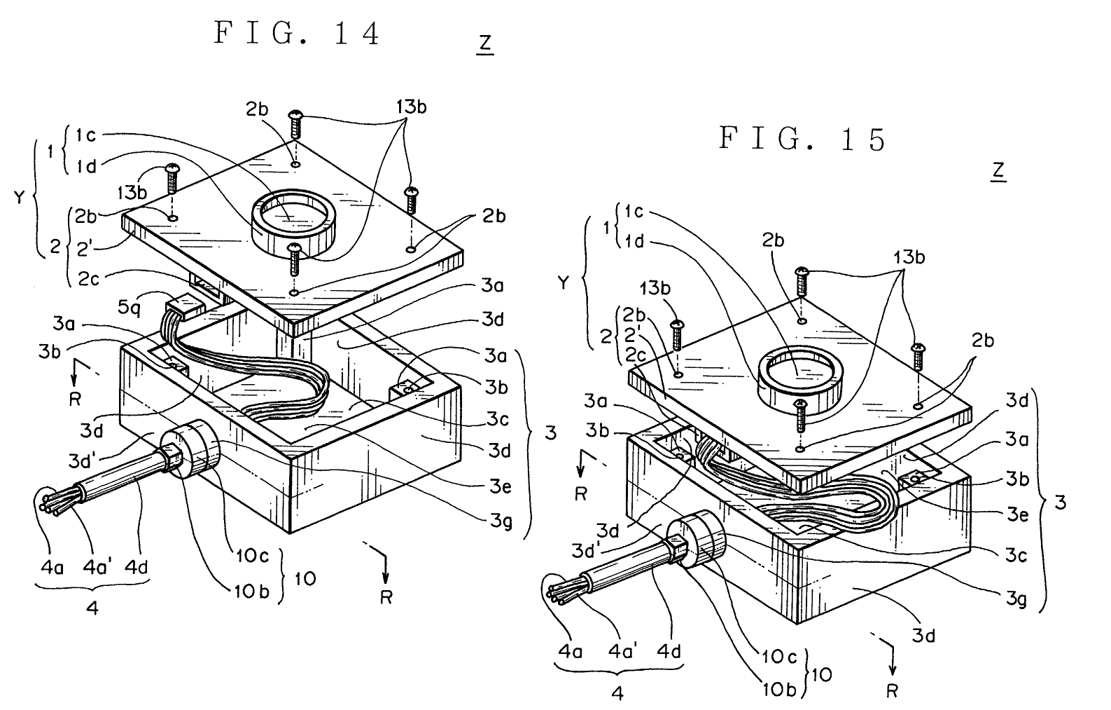

The inconvenience that might occur in assembling the conventional camera module Z as shown in FIG. 15 can be removed. Specifically, conventionally, when the base plate 2 to which the camera is attached is mounted in the camera case 3, the cables 4a,4a′ might be caught between the base plate 2 and camera case 3.

There was a fear of internal breakage of the cables 4a, 4a′. Therefore, the camera module Z which provide such fear must be dealt with as an inferior good. There was a fear of poor electrical contact owing to breakage of the cables 4a, 4a′.

Discarding such a semi-finished products is not preferred from the standpoint of environmental friendliness, and come to nothing in production. Therefore, there was also necessity of assembling the camera module by replacement of the wire harness 4 and the clamp 10 relative to it. However, in accordance with this invention, the above inconvenience in assembling the camera module can be removed without executing such a troublesome operation.

A detailed explanation will be given of the respective parts shown in FIGS. 1, 3 and 5. The camera 1 is composed of a camera body 1 equipped with CCD, screw-fastening portion 1a, screw-fastening holes 1b, lens 1c, lens peripheral portion 1d and positioning holes 1e, etc. In order to position/secure the camera body 1′ and a base plate body 2′ precisely, the positioning holes 1e are made at the four corners in the camera body 1′. Projections 2d for positioning are formed on the rear side of the base plate body 2′ as shown in FIG. 1 so as to correspond to the positioning holes 1e.

As seen from FIG. 5, the base plate body 2′ is equipped with screw-fastening portions 2a and projections 2d. The projections 2d made at the four corners of the base plate 2 are fit in the positioning holes 1e at the four corners of the camera body 1′ so that the camera 1 and base plate 2 are combined accurately.

As seen from FIGS. 1, 3 and 5, the base plate 2 is equipped with a caulking connector 5a on the lower face thereof. The caulking connector 5a includes a connector housing 5b and caulking terminals 5e. The connector housing 5b is composed of a top wall 5c and a pair of guiding walls provided on both ends thereof. The caulking connector 5a is located to a prescribed position of a base plate body 2′ and is formed as a part of the base plate 2.

The caulking connector 5a is composed of six crimping terminals 5e and a connector housing 5b. The caulking terminals 5e each having a prescribed length L1 are aligned at regular intervals on the top wall 5c of the connector housing 5b.

As seen from FIGS. 3, 5 and 7, the pair of guiding walls 5d of the connector housing 5b, each is provided with a securing piece 20. The pair of guiding walls 5d each has a length L2 from the plane to which the caulking terminals 5e are attached to its tip.

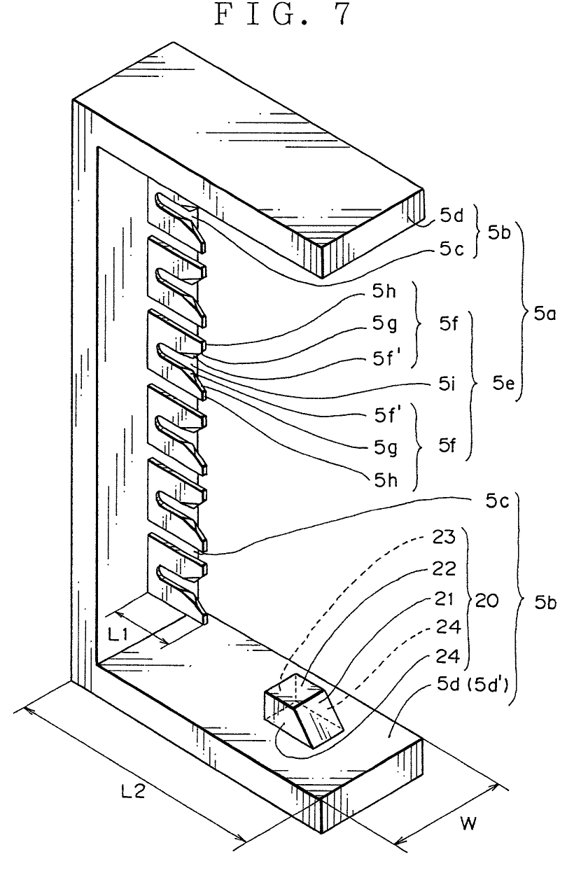

Referring to FIGS. 5 and 7, an explanation will be given of the securing piece 20. As clearly seen from FIG. 7, the securing pieces 20 are protruded from the opposite inner faces 5d′ of the pair of guiding walls 5d. This securing piece 20 is centrally of the width W of the guiding walls 5d, i.e. connector housing 5b.

As seen from FIGS. 5 and 7, the securing piece 20 is composed of an inclined face 21, a parallel face 22, vertical face 23 and a side face 24. The inclined face 21 is a slope which goes towards the interior of the [symbol] -shaped caulking connector 5a and toward the caulking terminals 5e.

The parallel face 22 is in parallel to the inner faces 5d′ of the pair of guiding walls 5d and located more internally of the caulking connector 5a than the inner faces 5d′. The vertical face 23 is perpendicular to the inner faces 5d′ and to the parallel face 22, and also in parallel to the plane on which the caulking terminals 5e are located.

The pair of side faces 24 are located on both sides of the inclined face 21, parallel face 22 and vertical face 23 so that they are perpendicular to the inner faces 5d′. As seen from FIG. 7, the distance between the side faces 24, i.e. the width of the securing piece 20 is more narrow than the width W of the guiding wall 5d. Such a securing piece 20 may be called a beak.

As seen from FIGS. 1 to 5, a connector housing 5j is installed within a chamber 3e of the camera case 3. The cables 4a, 4a′ are aligned at regular intervals within a chamber 5m of the connector housing 5j. A plurality of supporting portions 5m″ for supporting the cables 4a, 4a′ are provided so as to correspond to the caulking terminals 5e from the bottom wall 5k of the connector housing 5j on the side of the camera case 3 to an opening 5n of the connector housing 5j.

As seen from FIG. 5, the supporting portions 5m″ are aligned within the chamber 5m of the connector housing 5j so as to correspond to through-holes 5o made on the side wall 5k″ of the connector housing 5j shown in FIG. 4. The cables 4a, 4a′ are supported by the supporting portions 5m″. The connector housing 5j is installed within the chamber 3e of the camera case 3 so as to have a height H from the bottom wall 3c of the camera case 3 to the end face of the opening 5n.

As seen from FIGS. 3 to 5, a pair of engagement pieces 30 which correspond to the pair of securing pieces 20 are attached to the outer faces 5m′ of the connector housing 5j. The pair of engagement pieces 30, as seen from FIG. 5, are located in the vicinity of the lower part at a height of about ½ or less of the height H of the connector housing 5j from the bottom wall 3c of the camera case 3c.

A parallel face 32 is formed more internally of the connector housing 5j than and in substantially parallel to the outer face 5m′ of the side wall 5k′ of the connector housing 5. A vertical face 33 is formed to be perpendicular to the outer face 5m′ and the parallel face 32 and in parallel to the inner face of the bottom wall 3c of the camera case 3. Such engagement portions 30 may be called simply grooves.

The securing pieces 20, i.e. beaks are fit in the engagement pieces 30, i.e. grooves so that the camera module Y equipped with the caulking connector 5a can be coupled with the camera case 3 equipped with the connector housing 5j easily, quickly and surely.

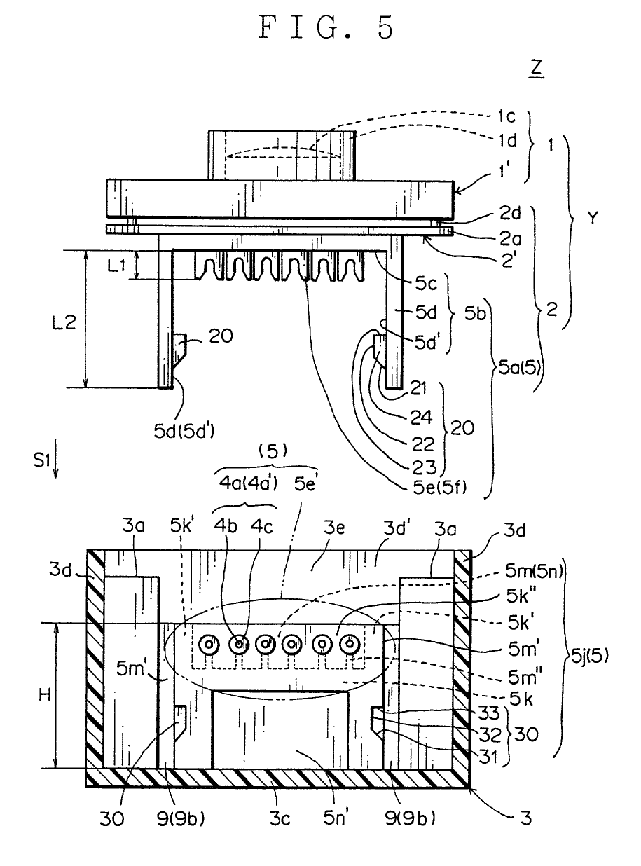

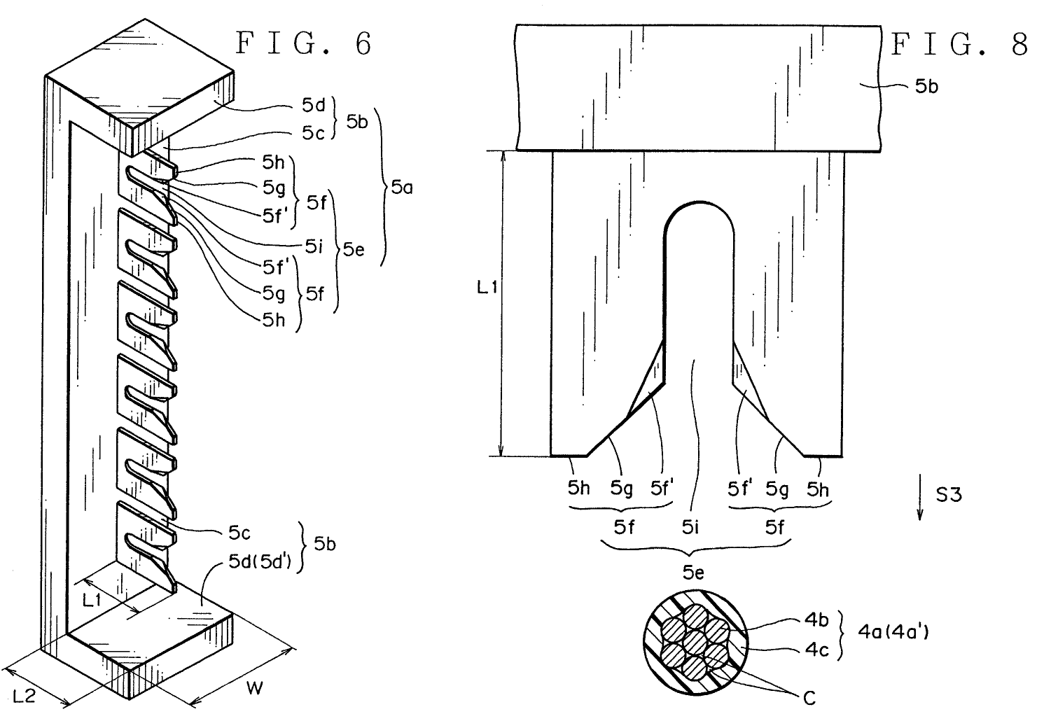

FIG. 6 is an enlarged perspective view of the caulking connector 5a shown in FIG. 1, and FIG. 7 is an enlarged perspective view of the caulking connector 5a shown in FIG. 3. The caulking connector 5a is composed of caulking terminals 5e each having blades 5f and the connector housing 5b. The caulking connector 5a is built in the base plate 2. The caulking terminals 5e are connected to various electric circuits provided on the base plate body 2′.

Six caulking terminals 5e are attached to the top wall 5c of the caulking connector 5a so that they are aligned in parallel at regular intervals. These caulking terminals 5e are located centrally for the width W of the connector housing 5b. These caulking terminals 5e each has a prescribed length L1 from the plane of the top wall 5c to the end 5h of the caulking terminal 5e.

The connector housing 5b of the crimping connector 5a includes the top wall 5c and a pair of guiding walls 5d on both ends thereof, and formed in a [symbol] -shape to have an uniform width W.

The pair of guiding walls 5d have opposite inner faces 5d′ which are perpendicular to the plane of the top wall 5c. These inner faces 5d′ are slidably kept in contact with the outer faces 5m′ of the connector housing 5j on the side of the camera case 3 shown in FIGS. 1, 3 and 5.

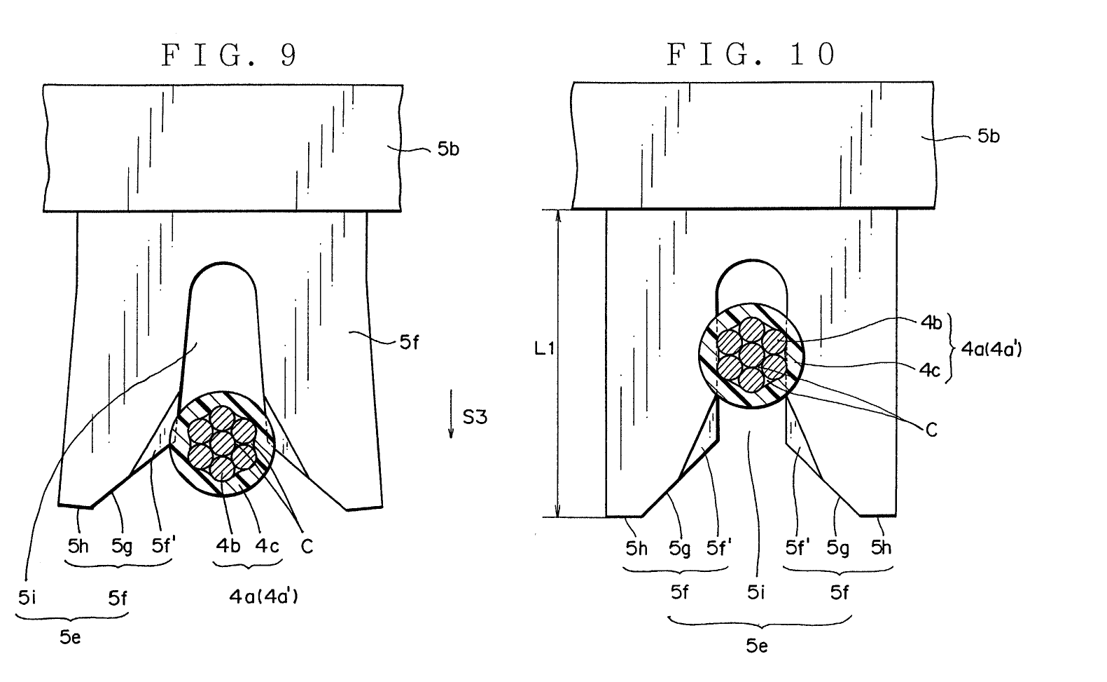

FIG. 8 is an enlarged view showing the state immediately before the caulking-connection between the caulking terminals shown in FIGS. 1, 3 and 5 and the cable 4a, 4a′ is started. In FIG. 8, the crimping terminal 5e is illustrated in an enlarged manner from that in FIGS. 6 and 7. FIG. 9 is an enlarged view of the state where the crimping-connection between the crimping terminal 5e and the cable 4a, 4a′ has been just started along a direction of arrow S. FIG. 10 is an enlarged view of the state where the caulking-connection between the caulking terminal 5e and the cable 4a, 4a′ has been completed along a direction of arrow S.

As seen from FIGS. 8 to 10, the cable 4a, 4a′ is a core wire composed of a plurality of conductors 4b and an insulating coating or tube 4c. There is slight gaps C among the conductors 4b. The insulating coating 4c and tube 4d of the cable 4a, 4a′ used in this invention may be made of e.g. soft resin or rubber, etc. The wire or wire harness 4, which is composed of the cables 4a, 4a′ and tube 4d, can be bent as necessary.

The conductor 4b is preferably made from a metallic wire which has good conductivity and a performance enough to endure repetitive bending. In this invention, the plurality of conductors 4b are bundled and twisted properly to provide the core wire having excellent strength. In order to increase the insulation property of the surface of the conductor 4b of the metallic wire, the conductor 4b coated with an enamel may be used for the wire harness 4.

The insulating coating 4c is preferably made from an insulating material which has a performance enough to endure repetitive bending. Such an insulating material includes synthetic resin, soft resin, rubber, or an admixture thereof.

Referring to FIGS. 1, 3 and 5, a detailed explanation will be given of the structure of the camera module Z. The caulking terminals 5e are integrally formed so as to be aligned on the top wall 5c. The caulking terminal connector 5a equipped with the caulking terminals 5e is located on a prescribed position of the base plate 2.

The connector housing 5j is installed in the chamber 3e of the camera case 3. The cables 4a, 4a′ are aligned within the connector housing 5j to provide a connecting portion 5e′. The base plate 2 equipped with the camera 1 is fit in the camera case 3 along the direction of arrow S1 so that the caulking terminal 5e is caulked with the cable 4a, 4a to provide a connector 5.

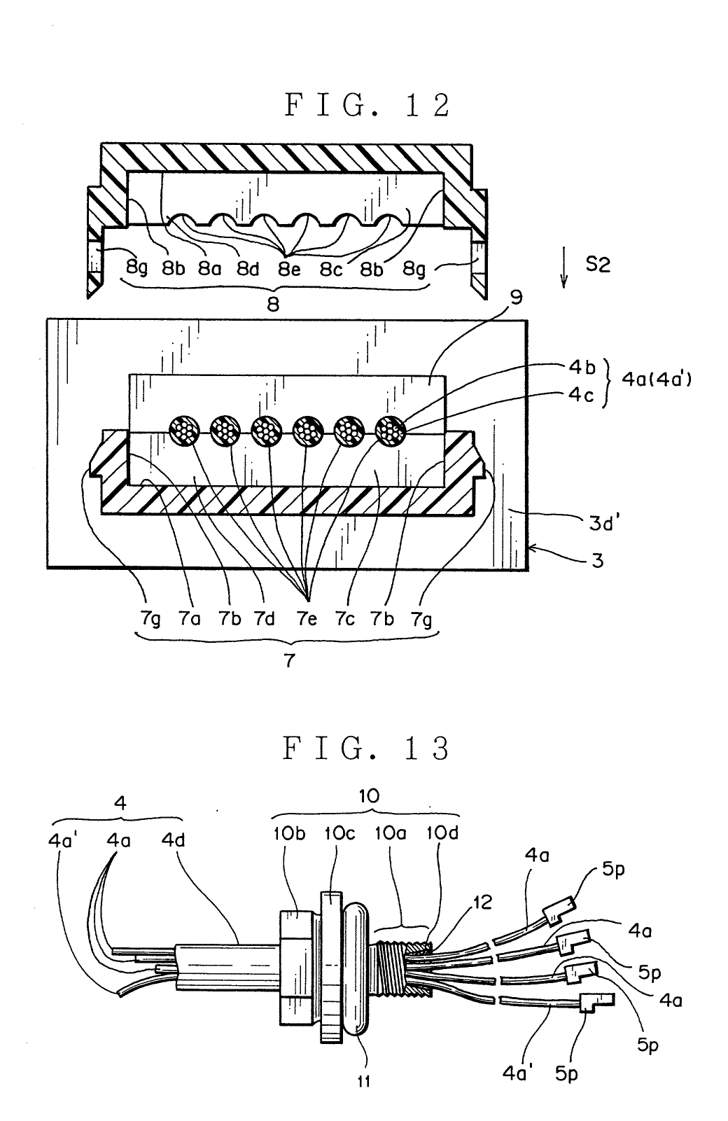

In this way, the caulking-connection using the caulking terminal 5e permits an electrical connection to be easily realized in assembling. Unlike the structure as shown in FIGS. 14 and 15 in which the connector housing 5q attached to the cables 4a, 4b is connected to the connector housing 2c attached to the base plate body 2′ to provide a connector, in accordance with this invention, as shown in FIGS. 1 and 3, the base plate 2 equipped with the caulking terminals 5e is coupled with the camera case 3 so that the base plate 2 and camera case 3 are electrically connected through the connector 5. Such a structure can be easily disassembled and is suitable to reduce the industrial waste which badly influences on the terrestrial environment.

Referring to FIGS. 6 to 8, a detailed explanation will be given of the shape of each of the caulking terminals 5e. The caulking terminal 5e is composed of a pair of caulking blades 5f having their opposite slopes 5g and arranged in parallel. Specifically, the caulking blades 5f have a pair of slopes 5g where the cable 4a, 4a′ start to enter. The slopes constitute sharp blade bodies 5f′.

The caulking terminal 5e has a caulking slit 5i in the vicinity of its vertical center line. The slit serves to permit the cable 4a, 4a′ to enter, and has a size which is more narrow than the diameter of the cable 4a, 4a′ and does not injure or break excessively the conductors 4b tied in a bundle. The caulking slit 5i is formed in a U-shape. Incidentally, the caulking terminal 5e maybe formed in another shape.

For example, the end 5h of the caulking terminal 5e is provided so that an operator's arm is not inadvertently injured by the sharp end of the caulking blade when the camera 1 and base plate 2 are combined to manufacture the camera module Y or the camera module is accommodated in the camera module. However, the end 5h may have a sharp tip according to the size or shape of the caulking terminal and portion where the caulking terminal is used.

Such a caulking terminal 5e is used for electric connection to the conductor 4b such as a core wire coated with an insulating coating 4c such as resin, rubber, composite material or enamel material. By caulking the crimping terminals 5e with the cables 4a, 4a′ each composed of a plurality of conductors 4b coated with the insulating coating 4c, the removal of the insulating coating 4c of the cable 4a, 4a′ and electrical connection of the conductor 4b thereof are simultaneously effected.

Now referring to FIGS. 9 and 10, a detailed explanation will be given of the operation of caulking the conductors 4b of the cable 4a, 4a′ into the caulking slit 5i of the crimping terminal 5e through the crimping blades 5f as shown in FIG. 8. As shown in FIG. 8, the operation of caulking the caulking terminal 5e in an appropriate orientation over the cable 4a, 4a′ is started in an attaching direction S3.

First, caulking of the caulking blades 5f of the caulking terminal 5e for the cable 4a, 4a′ coated with the insulating coating 4c is started. Then, as seen from FIG. 9, the sharp slope 5g, i.e. 5f′ of the sharp terminal 5e starts to tear the insulating coating 4c of resin or rubber of the cable 4a, 4a′, or of an thin enamel film covering the periphery of the conductors 4b. At this time, a pair of caulking blades 5f which constitute the caulking terminal 5e is opened so that the caulking slit 5i is slightly enlarged.

As the caulking proceeds, the caulking slit 5i formed centrally of the caulking terminal 5e is brought into contact with the internal conductors 4b of the cable 4a, 4a′ while tearing the insulating coating 4c, which results in a state as shown in FIG. 10. In this way, the caulking terminal 5e can simultaneously carry out the removal of the insulating coating 4c and the connection of the conductors 4b.

Thus, the caulking terminal 5e provided with the caulking blades 5f is brought into contact with the internal conductors 4b of the cable 4a, 4a, or conductor 4b coated with the enamel material, which results in a conducting state. Specifically, the caulking blades 5f of the caulking terminal 5e have only to be crimped on a prescribed portion of the conductor 4b to provide a conducting state.

Now, an explanation will be given of the terminal itself. The terminal can be classified into a caulking terminal and a crimping terminal. As described in connection with FIG. 10, the caulking terminal 5e is used to caulk the cable 4a, 4a′ with the conductor 4b coated with the coating 4c by the blades 5f′ of the caulking blades 5f of the caulking terminal 5e. In this case, the removal and insulating coating 4c and connection of the conductors 4b are simultaneously carried out. A typical example thereof is a terminal equipped with a U contact having the caulking slit 5i (simply referred as “slit”).

On the other hand, the caulking terminal is a terminal which is used to make the mechanical and electrical connection of an electric wire with the aid of a barrel which is plastically deformed using a crimping tool. Generally, the barrel includes a wire barrel for crimping a conductor portion of a wire except the portion coated with an insulating material and an insulation barrel for crimping the insulated portion of the wire. The wire barrel is classified into a closed barrel and an open barrel.

For example, in this invention, the caulking connector 5a may be replaced by a male connector or female connector incorporating the crimping terminal while the part including the cables 4a, 4a′ within the connector housing 5j may be replaced by the female connector or male connector in which a complementary terminal is housed.

The part of the cable 4a, 4a′ housed in the connector housing 5j may be made of a bus bar. The end of the bus bar may be formed in a prescribed terminal shape so that it can be connected to a connector component formed on the base plate. The terminal and connector in any format may be adopted as long as they do not injure the object of this invention.

Various kinds of electric components such as the bus bar, terminal and electric wire to be connected to each of the electric wirings are held in the base plate body 2′ shown in FIGS. 1 and 3. The base plate 2 is used to hold the various kinds of electric components and has a function of insulation to prevent poor electric contact from occurring among the various kinds of electric components. Such a base plate 2 can be referred to as an insulating plate.

The material of the base plate will be explained below. The material is preferably synthetic resin such as thermosetting resin or thermoplastic resin because it has excellent formability and can satisfactorily insulate various electric components such as bus bars, terminals, etc. For example, any synthetic resin with low water absorbing property can be used because of its size stability, mass productivity, stable electric performance, etc.

The bus bar is a conductive plate which is branched into a plurality of electric circuits with a large number of electric contacts, thereby providing an electric circuit network. The bus bar can include a bus bar body, connector bus bar, fuse bus bar, power source bus bar, etc. The fuse bus bar is also called a fork-type terminal. The bus bar may be provided with a relay terminal as occasion arises.

The caulking terminal 5e or bus bar used in this invention is made of e.g. copper material such as bronze and copper alloy, aluminum alloy, etc. However, the caulking terminal 5e or bus bar may be made of any material as long as it is a metal or conductor capable of passing a current.

The above material may be subjected to surface protection treatment such as plating in order to improve corrosion resistance. However, if it can sufficiently maintain the performance under a normal condition, such surface protection treatment should be omitted in view of the production cost.

As shown in FIGS. 1, 3 and 5, before the caulking terminal 5e is caulked with the cable 4a, 4a′, a pair of guiding walls 5d are formed so that they can be brought into slidable contact with the outer faces 5m′ of the side walls 5k′ of the connector housing 5j.

In this way, the pair of guiding walls 5d serve as a guide in slidable contact with the connector housing 5j on the side of the camera case 3. In this way, as shown in FIG. 5, when the base plate 2 equipped with the camera 1 and caulking connector 5a is assembled with the camera case 3, the camera module Y is lowered toward the connector housing 5j on the camera case 3 in an proper posture without so great tilting. Thus, the camera module Y will be appropriately combined with the camera case 3.

After the camera module Y has been fallen in such a posture, the connector housing 5b will be coupled with the connector housing 5j on the side of the camera case 3. Therefore, the caulking terminals 5e attached to the caulking connector 5a will be connected to the cables 4a, 4a′ at right angles, respectively.

Thus, as shown in FIG. 10, the internal conductors 4b of the cable 4a, 4a′ can be surely brought into contact with the caulking slit 5i, thus preventing malfunction such as poor electric contact from occurring.

Now, the word “right angle” refers to the state that the direction of extending the wires such as the cables 4a, 4a′ is orthogonal to the planar portion of each of the plate-like caulking terminals 5e each with a pair of caulking blades 5f arranged in parallel.

If the caulking blades 5f and the cables 4a, 4a′ are connected in their tilted state, undue force is applied to the caulking terminal 5e so that the caulking blades 5f thereof may be deformed.

If the caulking blade 5f are deformed, the caulking slit 5i may not be surely brought into contact with the internal conductors 4b. In this state, poor electric contact will occur. This invention can avoid such malfunction.

As shown in FIG. 5, the length L2 of the pair of guiding portions 5d is longer than the length L1 of the caulking terminal 5e and shorter than the height H of the connector housing 5j provided within the chamber 3e.

The direction of the lengths L1, L2 and the height H is that when the camera module Y is lowered directly below it in the proper posture with no tilt, i.e. the vertical direction of the camera module Z.

In this way, the above malfunction is more difficult to occur. The pair of guiding portions 5d serve as guides more satisfactorily as their length L2 increases. To this end, the guiding portions 5d must be brought into slidable contact with the outer surface 5m′ of the connector housing 5j before the connection between the caulking terminal 5e and the cable 4a, 4a′ is started.

Since the length L2 of the pair of guiding portions 5d is longer than the length L1 of the caulking terminal 5e, the former can serve as the guides before the connection between the caulking terminal 5e and the cable 4a, 4a′ is started.

Since the pair of guiding portions 5d serve as the guide more satisfactorily as its length L2 is longer, the length L2 is preferably longer than ⅓ of the height H of the connector housing 5j, more preferably, longer than ½.

In order that the caulking connectors 5a are housed in the chamber 3e of the camera case 3, the length L2 must be shorter than the height H of the connector housing 5j. It should be noted that to increase the length L2 excessively makes it difficult to handle the caulking connector 5a and does not contribute to reduction of size/weight.

If the width W of the pair of guiding portions is also determined appropriately in proportion to the length L2, the stability of the guiding portions 5d is improved so that they can use its function more satisfactorily.

In this way, the caulking terminals 5e can be caulked with the cables 4a, 4a′, with the caulking blades 5f being perpendicular to the cables 4a, 4a′, relatively to the bottom wall 5k of the connector housing 5j and side wall 5k′ thereof in parallel to the cables 4a, 4a′.

As shown in FIGS. 3 and 5, the guiding portions 5d are provided with a pair of securing pieces 20. On the other hand, the connector housing 5j on the side of the camera case 3 is provided with a pair of engagement portions corresponding to the pair of securing pieces 20.

In this way, when the camera module Y is combined with the camera case 3, the connector housing 5b is temporarily coupled with the connector housing 5j of the camera case 3 with the aid of the pair of securing pieces 20 and the pair of engagement portions 30. Thus, provisional fixing of the camera module Y and the camera case 3 is continued until they are securely fixed by screws.

Meanwhile, even if there is a transporting step of the camera module Z when it is assembled, owing to vibration, undue force may be applied between the caulking terminal 5e and the cable 4a, 4a′ so that poor electric contact may occur at the area where good connection has been made. However, such an inconvenience can be avoided by this invention.

Further, when camera module Y is combined with the camera case 3, they may come off from each other inadvertently. A further combining operation increases the possibility of poor contact. Such an inconvenience can be also avoided by this invention.

Specifically, if the injured area of the cable 4a, 4a′ is subjected to caulking, an electric poor contact may be generated again. In this case, the entire wire harness 4 inclusive of the cables 4a, 4a′ must be replaced by a new wire harness, or otherwise a different area of the cable 4a, 4a′ must be subjected to the caulking. This invention can remove the necessity of such a troublesome operation, and provide the camera module permitting easy handling.

In operation, when the camera module Y as shown in FIG. 5 is lowered toward the camera case 3 along an attaching direction S1, the inner face 5d′ of the guiding portion 5d starts to fall into contact with the outer face 5m′ of the side wall 5k′ on the camera case 3. With the aid of the pair of guiding portions 5d, the camera module Y in a proper posture is lowered just under it toward the camera case 3.

As the camera module Y is lowered, owing to the slopes 21 of the securing pieces 20 of the connector housing 5b, the pair of guiding portions 5d try to expand smoothly in an opening direction. The ends of the parallel portions 22 move downward in slidable contact with the outer faces of 5m′ of the connector housing 5j. In this case, the pair of guiding portions 5d move while they sandwich the connector housing 5j on the side of the camera case 3 so that the camera module Y does not lean excessively.

Thereafter, the securing pieces 20 on the side of the camera module Y and the engagement portions 30 on the side of the camera case 3 are engaged with each other. Once the securing pieces 20 and the engagement portions 30 are engaged with each other, the camera module Y and camera case 3 are provisionally coupled with each other at their respective vertical portions 23 and 33 so that they do not come off easily from each other. The camera module Z permitting easy handling on the way of assembling can be provided.

The camera case shown in FIGS. 1 to 4 has an accommodating chamber 3e encircled by a bottom wall 3c and four side walls 3d and 3d′. As seen from FIGS. 1 to 5, and FIG. 12, a mat seal 9 for improving the sealing property is formed integrally to the side wall 3d′ of the camera case 3.

As seen from FIGS. 2 and 4, the mat seal 9 has internal through-holes 9a through which the cables 4a, 4a′ are to be passed. In this way, the cables 4a, 4a′ as shown in FIGS. 1 to 4, are extended into the camera case 3 through the mat seal.

Referring to FIGS. 2 and 4, a detailed explanation will be given of the shape of the mat seal 9. As seen from these figures, the mat seal 9 is integrally formed from the periphery of the through-hole 3f made in the side wall 3d′ of the camera case 3 to the side wall 5k″ of the connector housing 5j. In order that the mat seal 9 does not come off from the through-hole 3f of the camera case 3, the mat seal 9 is provided with securing portions 9b for preventing it from coming off on the side of the chamber 3e. The securing portions 9b are secured to the camera case 3 so that they are sandwiched between the inner face of the side wall 3d′ of the camera case 3 and the outer face of the side wall 5k″ of the connector housing 5j.

The mat seal 9 will be made as follows. First, the camera case 3 is manufactured by molding aluminum castings. Otherwise, the camera case 3 is molded using synthetic resin which can be subjected to injection molding and has thermoplastic property. The synthesized polymer such as fast silicon granules is poured into the peripheral portion of the camera case 3 inclusive of the through-hole 3f, and thereafter solidified in a prescribed shape to provide the mat seal 9.

In this case, with the cables 4a, 4a′ being previously fixed to the through-hole 5o of the connector housing 5j, the cables 4a, 4a′ and mat seal 9 may be integrated. On the other hand, with the through-holes 9a previously made in the mat seal 9, the cables 4a, 4a′ may be passed through the though-holes of the mat seal 9.

Thus, the mat seal 8 is integrally formed on the side wall 5k″ of the connector housing 5j. The cables 4a, 4a′ sealed by the mat seal 9 are passed from an entrance case toward the chamber 5 of the connector housing 5j. The through-hole 3f made in the side wall 3d′ is sealed by the mat seal 9.

The provision of the mat seal 9 permits the wires such as the cables 4a, 4a′ to be passed from the outside of the camera case 3 to the inside thereof, and also prevents foreign materials such as water and dust from invading the inside of the camera case 3.

As seen from FIGS. 1, 2 and 4, bodies 3a, 3a′ for securing the camera module Y are provided at the internal four corners of the camera case 3. Female screw corners 3b are formed in the corresponding bodies 3a, 3a′.

Referring to FIG. 1, an explanation will be given of the relative positions of the female screw holes 3b. When viewed from the side of the camera case 3 where the wire harness 4 is attached, the bodies 3a provided at two positions on this side are higher than the bodies 3a′ provided at two positions on the deep side. Correspondingly, the female screw holes 3b of the bodies 3a on this side are located at a higher position than the female screw holes 3b of the bodies 3a′.

This is because the screw securing portions 1a of the camera 1 and the screw securing portions 2a of the base plate 2 are different in the height direction of the camera case 3 when the camera module Y composed of the camera 1 and the base plate 2 is combined with the camera case 3.

The camera body 1′ is provided with two screw securing portions 1a and the base plate body 2′ is also provided with two securing portion 2a. Since the camera 1 and the base plate 2 are combined with each other, the camera module Y is provided with total four screw-securing portions 1a and 2a. In this case, the screw-securing portions 1a and 2a of the camera module Y are located at different heights so that the screw-securing portions 3a, 3a′ of the camera case 3 are correspondingly located at different heights.

The camera case 3 is preferably made of an aluminum alloy such as aluminum die casting which is lightweight and excellent in various viewpoints such as mechanical strength, corrosion resistance, workability, productivity, etc. It is important that the camera case 3 is made of the material having corrosion resistance since the CCD camera is exposed to the weather. The camera case 3 is preferably made of the material having a small specific gravity which contributes to the weight-reduction of a motor car. Concretely, the camera case 3 is preferably made of synthetic resin which can be injection-molded and has thermoplastic property because it is excellent in mass productivity.

As seen from FIGS. 1 to 5, the connector housing 5j is arranged at a prescribed position within the accommodating chamber 3e which constitutes the camera case 3. The connector housing 5j is integrated to the camera case 3 within the accommodating chamber 3e of the camera case 3. Although the connector housing 5j can be formed as a separate member, it is preferably integrated to the camera case 3 in order to reduce the number of components to realize size reduction and cost reduction.

As seen from FIGS. 2, 4 and 11, the connector housing 5j is encircled by a bottom wall 5k and side walls 5k′ and 5k″ to provide an accommodating chamber 5m. Further, as seen from FIG. 5, a lightening space 5n′ is provided between the bottom wall 3c of the camera case 3 and the bottom wall 5k of the connector housing 5j. In this way, by providing the lightening space 5n′ below the bottom wall 5k of the connector housing 5j, reduction in the weight and cost of the material can be realized. Accordingly, a light-weight and inexpensive camera module Z can be provided.

As seen from FIGS. 1 to 5, FIG. 11, the cables 4a, 4a′ are mounted in the accommodating chamber 5m of the connector housing 5j. As seen from FIGS. 1, 2 and 11, the cables 4a, 4a′ are held by wire fixing portions 6 provided on the bottom wall of the connector housing 5j. Further, the cables 4a, 4a′ are aligned at regular intervals within the accommodating chamber.

In order that the caulking terminals 5e of the caulking connector 5a are connected to the cables 4a, 4a′ located within the accommodating chamber 5m, an opening 5n is provided above the accommodating chamber 5m. When the camera module Y is combined with the camera case 3, the caulking terminals 5e enter the accommodating chamber 5m through the opening 5n and are caulked with the cables 4a, 4a′, respectively.

As seen from FIGS. 1, 2 and 11, the wire fixing portions 6 are provided in a staggered manner around the cable 4a, 4a′. FIG. 11 is an enlarged perspective view of the vicinity of a connecting are 5e when the cable 4a, 4a′ is attached to the wiring fixing portions 6. The connecting portion 5e′ corresponds to the caulking connector 5a provided with the caulking terminals 5e.

As seen from FIG. 2, if the adjacent wiring fixing portions 6 are staggered within the accommodating chamber 5m, the accommodating space of the accommodating chamber can be reduced. Thus, the camera case 3 can be miniaturized so that the auxiliary machine module such as the camera module Z can be miniaturized.

As seen from FIGS. 2 and 11, the wire fixing portions 6 are arranged at at least two positions for each cable 4a, 4a′. In FIG. 11, a pair of wire fixing portions are attached to the cable 4a, 4a′. In FIG. 2, the wiring fixing portions 6 are provided at the two positions in their linear direction, and at a total of 12 positions

In this way, since the cables 4a, 4a′ are fixed at prescribed positions during the caulking, when the caulking blades 5f of the caulking terminal 5e as shown in FIG. 9 start to tear the cable 4a, 4a′, the cable 4a, 4a′ cannot escape from the caulking force of the blades 5f and surely receive the force. This realizes a preferred caulking connection.

Incidentally, the cables 4a, 4a′ may not be fixed by the wire fixing portions, but may be fixed by the through-hole 5o made in the side wall 5k″ of the connector housing 5j so that it is fixed more surely.

An explanation will be given of the shape of the wire fixing portion 6 as shown in FIGS. 1, 2 and 11. As seen more clearly from FIG. 11, the wiring fixing portion 6 is hook-shaped. Specifically, the wire fixing portion 6 is composed of a pair of inverted L-segments to provide a gate shape, for example.

As seen from FIG. 11, the wire fixing portion 6 is composed of a bottom plate 6a, posts 6b and locking pieces 6c. The posts 6b are extended upright from the bottom plate 6a and communicate with the locking pieces 6c which prevent the cables 4a, 4a′ from coming off.

The locking pieces 6c each has a slope 6d which permits the cable 4a, 4a′ to be easily fit in the wire fixing portion 6. However, the locking pieces 6c each has also a face 6e in parallel to the bottom plate 6a, which extends from the tip of the locking piece 6a to the post 6b. The face 6e serves to prevent the cable 4a, 4a′ from coming off.

The gap 6g between the one tip 6f of the wire fixing portion 6 and the other tip 6f thereof is set at a distance that is shorter than the diameter of the cable 4a, 4a′ so as to prevent the cable 4a, 4a′ from easily coming off and permits the cable 4a, 4a′ to be easily fit in the wire fixing portion 6.

The length of the post 6b from the bottom plate 6a to the parallel face 6e is set at a length which is slightly shorter than the diameter of the cable 4a, 4a′. In addition, the cable 4a, 4a′ is sandwiched between the locking piece 6c and bottom plate 6a in order to prevent the cable 4a, 4a′ from easily moving owing to the caulking force applied to the caulking blades 5f of the caulking terminal 5 during the caulking.

Additionally, in the caulking connection, in order to absorb an error or a swing when the respective components are attached, a slight play is required between the cable 4a, 4a′ and the caulking blades 5f. To this end, the distance between the inside face of the one post 6b of the wire fixing portion 6 and the inside face of the other post 6b thereof is set at a length longer than the diameter of the cable 4a, 4a′.

Where the cable 4a, 4a′ are fixed as described above, when the caulking blades 5f start to tear the cable 4a, 4a′, the cable 4a, 4a′ can receive the caulking force of the caulking blades 5f. This permits preferred caulking.

The wire fixing portion 6 is preferably made of synthetic resin which can be injection-molded and has thermoplastic property. In this case, the wire fixing portion 6 maybe made of the same material as that of the connector housing 5j, and may be integrated to the connector housing 5j. The wire fixing portion 6 may be separately provided as a component of a different material within the accommodating chamber 5m of the connector housing 5j. The wiring fixing portion according to this invention may be formed in any shape and made of any material.

Within the accommodating chamber 5m as shown in FIGS. 3 to 5, the wiring fixing portion 6 having a shape similar to that shown in FIG. 11 can be arranged. However, as shown in FIGS. 3 and 4, if the through-holes 5o through which the cables 4a, 4a′ have been passed are provided and the distance between the two side walls 5k″ is relatively short, the cable 4a, 4a′ does not excessively deviate from the corresponding caulking terminal 5e. In such a case, the wire fixing portions are not required within the accommodating chamber 5m of the connector housing 5j on the camera case 3.

The cables 4a, 4a′ are bundled by the tube 4d to provide the wire harness 4 which is to be connected to a prescribed position of a motor car. In order that other electric circuits can be also connected as occasion demands, the wire harness 4 may include a dummy wire as well as the cable 4a and the drain wire 4a′.

As seen from FIG. 2, the wire harness 4 connects the camera case 3 with a non-water-proofing connector 5r provided within a vehicle V. The drain wire 4a′ which branches on the way from the wire harness 4 is provided with a terminal 5s at its one end and the terminal 5s is attached to a frame of a vehicle body B by a screw 13c. In this way, the drain wire 4a′ serves as an earth. Thus, the base plate 3 equipped with the camera 1 is electrically connected to the wire harness 4, the non-water proofing connector 5r, drain wire 4a′, etc.

As seen from FIGS. 1 to 4 and FIG. 12, an inlet case 7 is attached to the side wall 3d′ of the camera case 3. The inlet case 7 is provided to prevent the wire harness 4 from suffering from undue bending force, protect the cables 4a, 4a′ taken out from the tube 4d of the wire harness 4 and align the cables 4a, 4a′ taken out from the tube 4d.

Although the inlet case 7 may be attached to the camera case 3 as a separate component, it is preferably integrated to the camera case 3 to reduce the number of components.

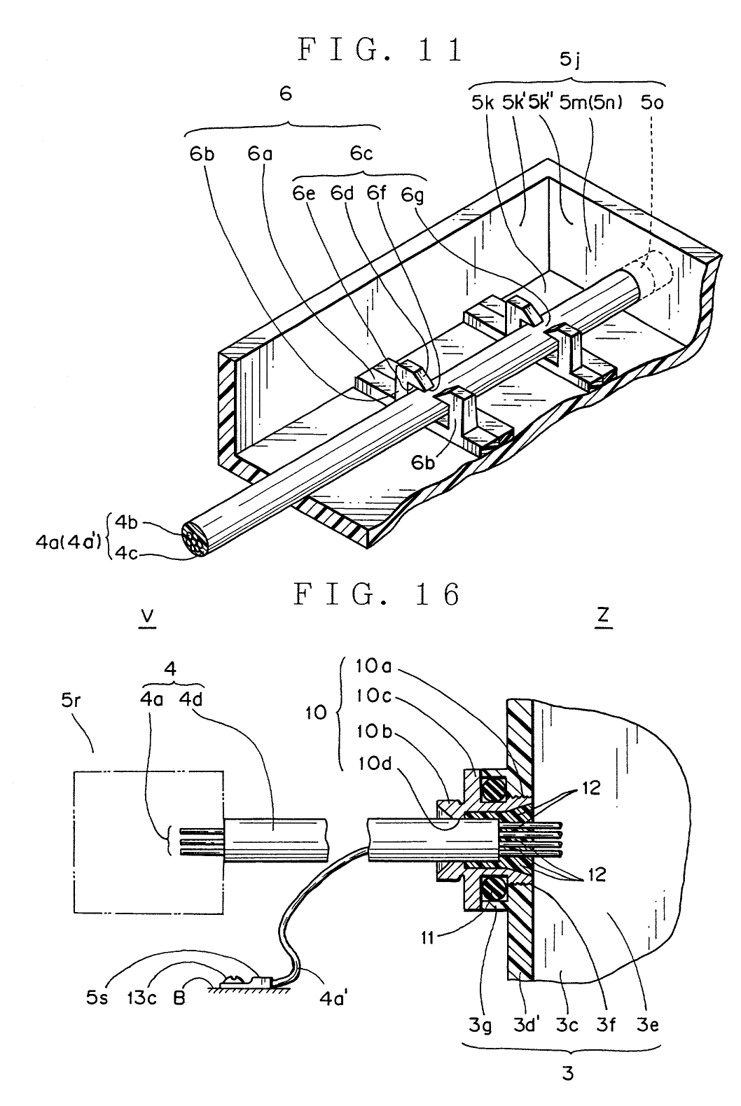

The inlet case 7 is composed of a bottom wall 7a and side walls 7b, 7b′ encircling it to provide an accommodating chamber 7c. A guiding plate 7 dislocated in the accommodating chamber 7c to align the cables 4a, 4a′ in parallel. Specifically, as seen from FIG. 12, guiding grooves 7e for appropriately guiding the cables 4a, 4a′, are formed on the upper side of the guiding plate at six positions at regular intervals. As seen from FIGS. 1 to 4, a guiding portion 7f for the wire harness 4 is provided so as to extend along the wire harness from the side wall 7b′ of the inlet case 7.

As seen from FIGS. 1, 3 and 12, an inlet cover 8 corresponding to the inlet case 7 is prepared. FIG. 12 is a sectional view of the inlet case 7 and inlet cover 8 taken in line P-P in FIGS. 1 and 3. The inlet cover 8 is composed of a top wall 8a and side walls 8b, 8b′ encircling it to provide an accommodating chamber 8c.

The inlet cover 8 is provided with a guiding plate 8d having guiding grooves 8e corresponding to the guiding grooves 7e of the guiding plate 7d of the inlet case 7. Specifically, guiding plate 8d for appropriately guiding the cables 4a, 4a′ is provided within the accommodating chamber 8c of the inlet cover 8.

Specifically, as seen from FIG. 12, guiding grooves 8e for appropriately guiding the cables 4a, 4a′, are formed on the lower side of the guiding plate 8d at six positions at regular intervals. Further, as seen from FIGS. 1 and 3, a guiding portion 8f for the wire harness 4 is provided so as to extend along the wire harness from the side wall 8b′ of the inlet cover 8.

In this way, in a direction S2 in FIG. 12, the inlet case 7 is securely covered with the inlet cover 8 so that the cables 4a, 4a′ are securely sandwiched between the guiding grooves 7e of the inlet case 7 and the guiding grooves 8e of the inlet cover 8. The guiding plates 7d and 8d provided with guiding grooves 7e and 8e, respectively can be referred to as ribs.

When the inlet case 7 is covered with the inlet cover 8, the guiding portions 7f and 8f are fit to each other. Therefore, the wire harness 4 is protected so that it does not suffer from undue bending force.

Because of provision of the guiding portions 7f and 8f, when the wire harness 4 is arranged or the assembled camera module Z is dealt with, the wire harness 4 does not curve in a sharp curve at the attaching portion where the wire harness is attached to the camera case 3 and hence the cables 4a, 4a′ do not suffer from undue force.

As seen from FIGS. 1, 3 and 12, the inlet case 7 is provided with a pair of locking segments 7g formed on the side wall 7b of the inlet case 7, whereas the inlet cover 8 is provided with a pair of engagement segment 8g formed on the side wall 8b of the inlet cover 8. The inlet case 7 and inlet cover 8 are securely engaged with each other in such a manner that the locking segments 7b which have protrusive shapes are fit in the corresponding engagement segments 8g having engagement windows.

The inlet cover 8 is preferably made of synthetic resin which can be injection-molded and has thermoplastic property because it is excellent in mass productivity. The inlet cover 8 can be manufactured by the other technique than the injection molding. Where the camera case 3 is made of the same material as that of the inlet case 7 and inlet cover 8, the assembly can be mass-produced in a complicate shape.

Since the inlet cover 8 made of synthetic resin has suitable restoring force, when the locking segments 7g of the inlet case 7 are fit in the engagement segments 8g of the inlet cover 8, the engagement segments 8g are elastically deformed. Therefore, the locking segments 7g of the inlet case 7 can be easily fit in the engagement segments 8g of the inlet cover 8. As a result, the inlet case 7 and the inlet cover 8 are fit to each other quickly and easily.

For the reason described above, if the connector housing 5b of the caulking connector 5a and wiring fixing portion 6 are also made of the above synthetic resin, they can be formed into a molding body with suitable elastic force, and hence used as a light-weight and elastic component which can be satisfactorily attached to a complementary component.

The synthetic resin which can be injection-molded and has thermoplastic property includes e.g. polybutyleneterephthalate (PBT), acrylnitrile-butadiene stylene (ABS), polypropylene (PP), etc. The inlet cover 8 is made of e.g. polybutyleneterephthalate (PBT) which is excellent in size stability, strength stability, electric characteristic, etc.

Now referring to FIGS. 1 to 12, an explanation will be given of a method of manufacturing an auxiliary machine module such as the camera module Z, particularly a method of assembling the camera module Z as described above.

Various terminals such as various kinds of caulking terminals 5e and various bus bars are made in prescribed shapes from a metallic material by punching or bending. On the other hand, the base plate is prepared from thermosetting resin, and the connector housing 5b is injection-molded from thermoplastic resin. Various electric components such as the various bus bars and connector housing 5b equipped with the caulking terminals 5e are attached to the base plate 2.

The camera 1 which includes a lens 1c, a lens peripheral portion 1d, a camera 1, etc. as shown in FIG. 1 is previously prepared. As shown in FIG. 1, the camera 1 is combined with the base plate 2 having the caulking connector 5a equipped with the caulking terminals 5e and other various electric circuits to prepare the camera module Y.

On the other hand, the camera case 3 equipped with the connector housing 5j and inlet case 7 as shown in FIG. 1, inlet cover 8 and the wiring fixing portion 6 are previously manufactured of the synthetic resin which can be subjected to the injection molding and has a thermoplastic property. As seen from FIGS. 2 and 11, the wire fixing portion 6 is attached to a prescribed position within the connector housing 5j, or integrally molded with the connector housing 5j using the same material.

As regards the wire harness 4 as shown in FIG. 2, the cables 4a, 4a′ are previously taken out from the tube 4d by tearing it so that the cables 4a, 4a′ are extended from the tube 4d by a prescribed length.

The cables 4a, 4a′ are passed through the through-holes 5o formed on the side wall 5k″ of the connector housing 5j, respectively, and attached to the wire fixing portions 6 located within the accommodating chamber 5m of the connector housing 5j. The cables 4a, 4a′ each is securely fixed to two wire fixing portions 6.

As occasion demands, the cables 4a, 4a′ may be fixed to the side wall 5″ by using adhesive so that the cables 4a, 4a′ can be fixed to the side wall 5″ more securely.

As seen from FIGS. 1 to 4 and 12, the cables 4a, 4a′ are securely aligned on the guiding grooves 7e formed in the guiding plate 7d of the inlet case 7. Subsequently, the synthetic polymer such as the fast granular silicon is poured into the through-hole 3f of the camera case 3 and solidified into a prescribed shape to the mat seal 9.

The camera module Y is securely accommodated into the camera case 3. In the process of this operation, the caulking blades 5f of each caulking terminal 5e tears the insulating coating 4c of the cable 4a, 4a′ arranged in the connector housing 5j so that they are brought into contact with the insulating coating 4c. Thus, the caulking connection is made within the camera module Z. In this way, by securely accommodating the camera module Y within the camera case 3, the base plate 2 or camera module Y is electrically connected to the camera case 3 with the aid of the connector 5.

In accordance with this invention, unlike the conventional camera module Z as shown in FIG. 14, the camera module Z can be assembled without performing the troublesome operation that the connector housing 5q equipped with terminals is attached to the cables 4a, 4a′, is passed through the through-hole of the camera case and thereafter connected to the connector housing 2c attached to the base plate 2 equipped with terminals so that as shown in FIG. 15, the base plate 2 is electrically connected to the cables 4a, 4a′. Therefore, in accordance with this invention, the camera module Z can be assembled quickly and effectively.

In accordance with this invention, the problem which may occur when the camera module Y is combined with the camera case 3 as shown in FIGS. 14 and 15, can be solved. Specifically, such an inconvenience can be overcome that when the base plate 2 is combined with the camera case 3, the cables 4a, 4a′ are caught between the base plate 2 and the camera case 3.

More specifically, in the conventional camera module Z as shown in FIG. 15, when the camera module Y is mounted in the came case 3, the redundant portion of the cables 4a, 4a′ may extend off between the camera module Y and the camera case 3. Therefore, when the camera module Y is attached to the camera case 3, because of the redundant portion extended off, the cables 4a, 4a′ will be caught between the camera module Y and camera case 3. Such an inconvenience does not occur in this invention.

Thus, the operator is not required to perform the assembling operation carefully so that the cables 4a, 4a′ are not caught between the base plate 2 and the camera case 3. Further, when an automated assembling machine is used, it does not catch the cables 4a, 4a′ and so not stop. Therefore, the cables 4a, 4a′ are not injured so that the production yield of the camera module Z in the manufacturing process is not lowered.

Now referring to FIGS. 1 and 3, a concrete explanation will be given of a method of manufacturing an auxiliary module according to this invention. The camera base plate 2 equipped with the caulking connector 5a is attached to the camera 1 to assemble the camera module Y. On the other hand, the cables 4a, 4a′ are securely aligned at regular intervals in the accommodating chamber 5m attached to the camera case 3. Simultaneously when the camera module Y equipped with the base plate 2 is mounted in the camera case 3, the caulking terminals 5e attached to the camera module Y are caulked with the cables 4a, 4a′ of the camera case 3.

In accordance with such a method of manufacturing the camera module, the camera module can be assembled more easily than the conventional assembling operation. Thus, the assembling operation can be simplified, and the efficiency of operability can be improved. In the manufacturing process, using the caulking-connection of the caulking terminals 5e, the assembling operation of the camera module and the electric connection therefore can be simultaneously carried out.

By assembling the camera module Z as described above, i.e. mounting the camera module Y in the camera case 3, the electric connection can be made. The caulking-connection using the caulking terminals 5e, as described in connection with FIGS. 8 to 10, permits peeling of the insulating coating 4c and connection of the conductor 4b to be carried out simultaneously. This connecting method is very efficient.

This invention can avoid the troublesome operation in the conventional connecting method described with reference to FIG. 13 that after the insulating coating of the cable 4a, 4a′ has been removed to expose the internal conductor, the conductor is connected to the crimping terminal to provide the terminal 5p, and the prescribed crimping terminals are connected to each other.

Unlike the prior art as shown in FIGS. 14 to 16, in accordance with this invention, the camera module Z can be assembled without performing the troublesome operation that the connector housing 5q equipped with terminals is attached to the cables 4a, 4a′, is passed through the through-hole of the camera case and thereafter connected to the connector housing 2c attached to the base plate 2 equipped with terminals so that as shown in FIG. 15, the base plate 2 is electrically connected to the cables 4a, 4a′. Therefore, in accordance with this invention, the camera module Z can be assembled quickly and effectively.

In this invention, although the caulking connection was performed using the caulking terminals 5e, male-female connectors in any other format may be used.

After the camera module Y shown in FIGS. 1 and 3 have been accommodated in the camera case 3 in an attaching direction S1, four screws 13a are passed through the through-holes 1b, 2b formed at the screwing portions 1a, 2a. The attaching direction S1 is vertically oriented so that the flat portion of the camera body 1′ or base plate 2′ is in parallel to the bottom wall 3c of the camera case 3.

The screws 13a are screwed into the female screw holes 3b of the securing pieces 3a, 3a′ provided at the four corners of the camera case 3 using the screwing tool. In this case also, the caulking-connection can be carried out more surely. As occasion demands, the cover for protecting the auxiliary machine 1 may be attached to the camera case 3.

As seen from FIG. 12, since the inlet cover 8 is made with the inlet case 7, the cables 4a, 4a′ are surely fixed by the guiding grooves 7e and guiding grooves 8e.

The camera module Y as shown in FIG. 1 may be combined with the camera case 3 in which the connector housing is accommodated as shown in FIGS. 3 and 4. In this case, the engagement pieces 30 shown in FIGS. 3 and 4 may not be processed.

The auxiliary machine module used in this invention may include an auxiliary module used in an instrument panel of a motor vehicle and its peripheral portion.

However, the auxiliary machine module is preferably the camera module including the CCD camera 1 attached to the motor vehicle. Use of the camera module Z attached to the motor vehicle permits the number of peripheral components of the camera module Z to be reduced.

In accordance with this invention, the assembling structure of the camera 1, base plate 2 and camera case 3 can be simplified. Specifically, as shown in FIGS. 1, 3 and 5, use of the caulking terminals 5e makes it unnecessary to use the structure of the conventional camera module as shown in FIGS. 13 and 16 in which the cables 4a, 4a′ equipped with the terminals 5p is combined with the connector housing 5q and thereafter, as shown in FIGS. 14 and 15, the connector housing 5q is connected to the connector housing 2c of the base plate 2.

In accordance with this invention, since the caulking terminals 5e of the caulking connector 5a as shown in FIGS. 1, 3 and 5 are electrically connected to the cables 4a, 4a′ arranged in the chamber 5m on the side of the camera case 3, inspection, dismantle and repair of the camera module can be made easily. Easiness of dismantle of the camera module contributes to recycling thereof.

The camera module according to this invention is used in a motor vehicle, a large-scale car such as a bus, etc. The camera module is attached to a region in a blind spot of the front of the motor vehicle, or a rear thereof from which a rear field of vision can be ascertained. Thus, the camera module can be used to ascertain the blind spot.

Meanwhile, when the motor car backs, the in-vehicle CCD camera attached to the exterior of the rear of the car may bump against any other object. In this case, the CCD camera must be inspected and repaired. However, the in-vehicle CCD camera to which this invention should be applied can be easily dismantled, and repaired. Therefore, the CCD camera to which this invention can be applied is preferably attached to the rear of the vehicle in order to ascertain the field of vision.

Since the CCD camera to which this invention can be applied, when it is out of order, can be easily removed, inspected and repaired, its maintenance can be made very easily. Further, since the camera module Z out of order can be also dismantled easily, it is not directly disposed of, but can be recycled.

What is claimed is:

1. An auxiliary machine module comprising:
an auxiliary machine;
a base plate equipped with said auxiliary machine and a caulking connector;
a case in which said base plate is mounted, and
a connector means for electrically connecting said base plate and said case.

2. An auxiliary machine module according to claim 1, wherein said caulking connector is composed of a first connector housing and caulking terminals and said case has a second connector housing in which electric wires are housed, and said connector means is formed when said base plate is mounted in said case so that the caulking terminals are caulking-connected to the electric wires.

3. An auxiliary machine module according to claim 2, wherein said first connector housing has a pair of guiding walls which are to be brought into sliding-contact with the said second connector housing before said caulking terminals are caulking-connected to the wires, respectively.

4. An auxiliary machine module according to claim 3, wherein said guiding walls are longer than the caulking terminals and shorter than a height of said second connector housing.

5. An auxiliary machine module according to claim 3, wherein said first connector housing has a pair of locking pieces and said second connector housing has a pair of engagement portions to be engaged with said pair of locking pieces.

6. An auxiliary machine module according to claim 1, wherein said auxiliary machine is a camera attached to a motor vehicle so that said auxiliary machine module constitutes a camera module.

7. A method of manufacturing an auxiliary machine module comprising the steps:
attaching an auxiliary machine to a base plate; and
mounting said base plate in a case so that said base plate is electrically connected to said case by means of a connector means.

8. A method of manufacturing an auxiliary machine module according to claim 7, wherein said base plate has a caulking connector composed of a first connector housing and caulking terminals and said case has a second connector housing in which electric wires are housed, and said connector means is formed when said base plate is attached to said case so that the caulking terminals are caulking-connected to the electric wires.

9. A method of manufacturing an auxiliary machine module according to claim 7, wherein said auxiliary machine is a camera attached to a motor vehicle so that said auxiliary machine module constitutes a camera module.
